(19) United States
(12) Patent Application Publication
(10) Pub. No.: US 2026/0131929 A1
(43) Pub. Date: May 14, 2026

(54) BREAST MILK STORAGE SYSTEM

(71) Applicants: Martin von Dyck, Concord, NC (US); Jane Reinard, Kintnersville, PA (US); Peter Gorky, Bridgewater, NJ (US)

(72) Inventors: Martin von Dyck, Concord, NC (US); Jane Reinard, Kintnersville, PA (US); Peter Gorky, Bridgewater, NJ (US)

(21) Appl. No.: 18/947,628

(22) Filed: Nov. 14, 2024

(51) Int. Cl. B65D 1/36; A61J 1/16

(52) U.S. Cl. CPC B65D 1/36; A61J 1/16

(57) ABSTRACT

A fluid storage system providing a bin dimensioned and shaped to receive at least one tray insert, wherein each tray insert has a plurality of compartments, and wherein each compartment is dimensioned and shaped to receive a fluid container, wherein the fluid container is supported on a base of the compartment so that the fluid container is prevented from tilting more than forty-five degrees relative to the base.

### BACKGROUND OF THE INVENTION

The present invention relates to breast milk storage and, more particularly, to a breast milk storage system.

Expressed breast milk can be stored, but storage of breast milk in refrigerators and or freezers often results in leakage, spillage, and loss of milk.

Presently, medical professionals and mothers are using readily available plastic bins that do not secure the individual breast milk storage containers. Moreover, current bins allow the breast milk containers to tip, fall over, and leak their contents. Nothing exists on the market that will help address these breast milk storage concerns for hospital and or home use in refrigerators and or freezers.

Neonatal intensive care unit (NICU) nurses preload syringes of varying sizes with mothers'milk and/or donor milk to feed babies in a NICU, such milk is stored for a 12-to-24-hour period in a refrigerator. These syringes need to be kept separated and controlled for each specific patient. When the syringes are preloaded with milk the syringe plunger is nearly fully extended, which approximately doubles the overall length of the syringe (twice the length of the syringe barrel), thereby taking up additional space.

As can be seen, there is a need for a breast milk storage system that provides secure storage compartments for the variety of breast milk storage containers, such as bottles, bags, jars, etc.

### SUMMARY OF THE INVENTION

The present invention is specifically designed to allow for the secure storage of various types and shapes of breast milk containers.

The single and double wide, open trays used with or without the bins allow convenient storage and organization of the preloaded syringes. The single and double wide open tray designs can be used with or without the bins, thereby allowing convenient storage and organization of the preloaded syringes. The trays for the preloaded syringes can be stacked one on top of another saving valuable space.

In one aspect of the present invention, a fluid storage system providing a bin dimensioned and shaped to receive a tray insert, wherein the tray insert has a plurality of compartments, each compartment is dimensioned and shaped to receive a fluid container, wherein the fluid container is supported on a base of the compartment so that the fluid container is prevented from tilting more than forty-five degrees relative to the base. Generally, the dimensions of each compartment are designed to specifically accommodate each type of container, thereby creating an optimal fit to easily place, maintain, and remove a container an upright position.

In the embodiments including pre-filled or loaded syringes, the items will be laid perpendicular to the ground, but the Luer fittings will be oriented in a top orientation.

In another aspect of the present invention, wherein the plurality of compartments provides a first compartment having a first circular cross-section; a second compartment having a second circular cross-section, wherein the first circular cross-section is at least twenty percent larger diametrically; and a third compartment having a rectangular cross-section; further providing a lid dimensioned and shaped to close off an opening of the bin so that another bin can be stacked on the lid in a nested arrangement; and a fluid capture lip along a periphery of an outer perimeter of the tray, wherein the bin, the tray, and the lid are designed from reusable or disposable plastic, wherein the bin is transparent enabling visualization therethrough or opaque to protect each fluid container from light exposure, wherein the tray insert has handles, wherein the bin has fingerholes, wherein the tray insert has a raised tab to assist with removal and insertion of the tray insert, wherein the tray insert has a slide pocket for insertion of patient indicia or an identification area for display of patient indicia, and wherein the fluid container contains breast milk.

In yet another aspect of the present invention, a storage system for a plurality of syringes loaded with a milk includes the following: a bin dimensioned and shaped to receive a tray insert, wherein the tray insert defines a plurality of elongated channel slots, each elongated channel slot dimensions and shaped to secure one of a plurality of syringe barrels in a spaced apart relationship relative to each other; each of the plurality of the elongated channel slots includes a floor having a notch for receiving a portion of a barrel flange of the respective syringe barrel in a locked engagement preventing the syringe barrel from moving longitudinal along the elongated channel slot; and a drip well located at a well elevation lower than an elevation of said floor, where in the locked engagement a tip of the respective syringe barrel is suprajacent the drip well, wherein the floor is sloped downwardly from the drip well toward a plunger end of the respective syringe barrel so that fat is the fluid would be urged by gravity toward said plunger end, and wherein for each respective syringe barrel a tip thereof is disposed off-center relative a tip wall of the syringe barrel, and wherein the locked engagement the tip is diametrically opposed to the drip well relative a center of said tip wall, whereby the combination of the off-center and diametrically opposed disposition in combination facilitates accumulation of the colostrum and fat on the top of the loaded milk, allowing it to be administer to the patient with greater efficiency.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use.

FIG. 2 is a perspective view of an exemplary embodiment of a systemic tray the present invention.

FIG. 3 is an exploded perspective view of an exemplary embodiment of the present invention, illustrating placement of systemic components.

FIG. 4 is a perspective view of an exemplary embodiment of a systemic tray the present invention.

FIG. 5 is a perspective view of an exemplary embodiment of a systemic tray the present invention.

FIG. 6 is a perspective view of an exemplary embodiment of a systemic tray the present invention.

FIG. 7 is a perspective view of an exemplary embodiment of a systemic tray 60 the present invention, illustrating a tray insert 62 for securing a plurality of syringes 68 in a spaced-apart relationship with each other.

FIG. 8 is a section view taken along line 8-8 in FIG. 7.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

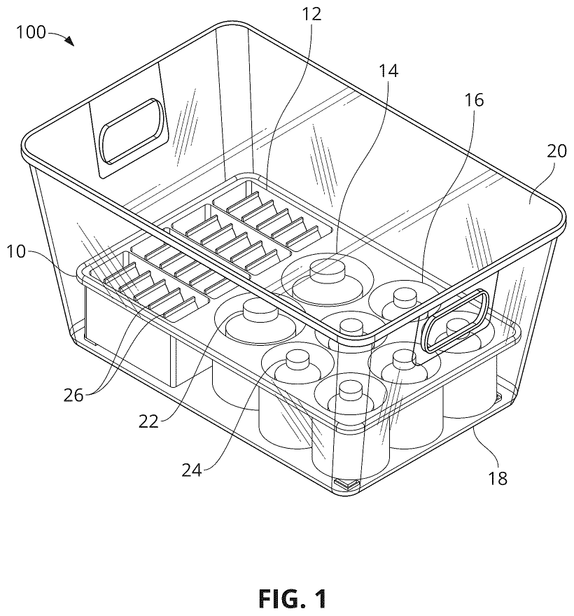

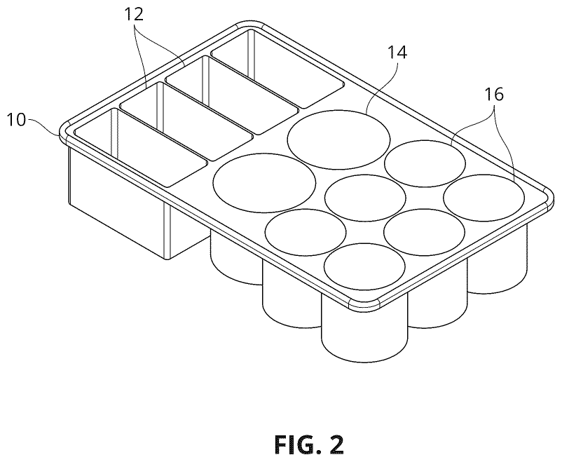

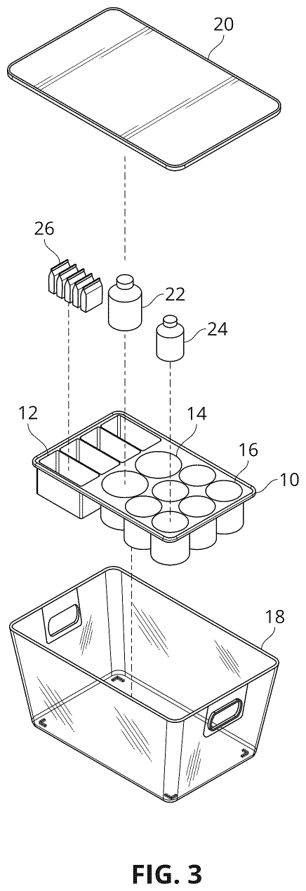

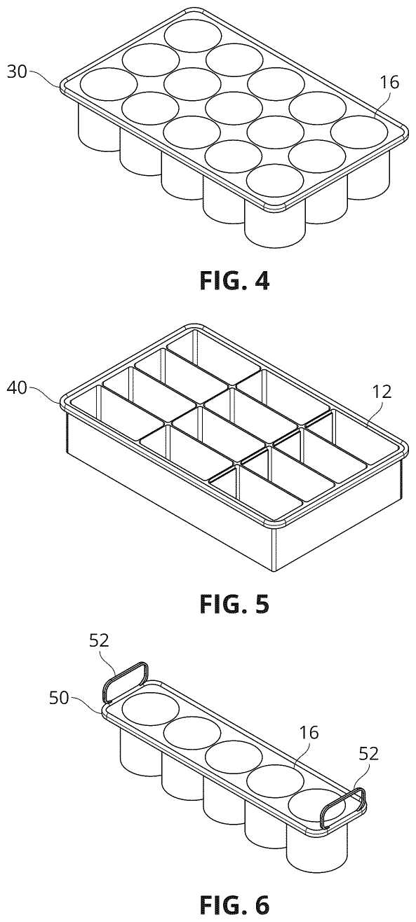

Referring to FIGS. 1 through 6, the present invention, an embodiment of the present invention provides a breast milk storage system 100. The breast milk storage system 100 may include a transparent or opaque bin 18 for receiving one or more tray inserts 10, 30, 40, and 50. Each tray insert 10, 30, 40, and 50 may include one or more first, second, and third compartments 12, 14, and 16, wherein each compartment is dimensioned and shaped for removably housing a breast milk container 22, 24, or 26, respectively. A lid 20 for the bin 18 enables stacking of a plurality of bins 18 on top of each other.

The first breast milk container 22 may be a pouch, the second breast milk container 24 may be a large bottle, and the third breast milk container 26 may be a small bottle. It is understood that other container types may have their complementary compartment provided by one of the trays 10, 30, 40, and 50.

The first compartment 12 may be a rectangular cross-section. The second and third compartments 14 and 16 may have a circular cross-section. Again, it is understood that other compartments with other cross-sections (some which are non-uniform throughout their depth) are contemplated by the present invention.

A first tray insert 10 may have at least of a plurality of first, second, and third compartments 12, 14, and 16. A second tray insert 30 may have a plurality of only third second or third compartments 12 or 16. A third tray insert 40 may have a plurality of only first compartments 12. A fourth tray insert 50 may have a plurality of only second or third compartments 12 or 16.

The fourth tray insert 50 may have only a single row of compartments 12, 14, or 16, as opposed to the first, second, and third trays 10, 30 and 40 having an array of rows and columns of first, second, and third compartments 12, 14, or 16. As a result, a plurality of fourth trays 50 may be received in the bin 18 at the same relative elevation. The fourth tray insert 50 may have a handle 52 on each opposing end.

The construction of the present invention may utilize complex molds and tooling to allow for low coat manufacturing of the systemic device. The present invention can be injection molded, vacuum molded (formed) and 3D-printed including a combination of the methods. Rigid plastic or semi-rigid plastic is preferred for the construction of the present invention. Dishwasher safe plastics that can survive a hot dishwasher cleaning without distortion and/or changing critical shapes and dimensions.

The user of the present invention will select the appropriate tray insert 10, 30, 40, and/or 50, depending on the type or types of breast milk containers needed to be securely stored and place the tray insert 10, 30, 40, and/or 50 into bin 18. Then, the user will insert the breast milk containers 12, 14, and/or 16 into the appropriate pockets/compartments in the tray insert. Doing so will prevent the breast milk containers from tipping and spilling their contents.

The present invention will help store breast milk contained in a variety of containers, such as syringes, milk bags, milk bottles and milk cans of various sizes and shapes. The primary function is to hold these milk containers in such a manner that they will not tip over or tilt more than 45 degrees, thereby minimizing milk spillage.

Additionally, the present invention could be used to store bottles and pouches of various sizes and shapes that contain food, baby food, feeding formula. Also, the present invention is designed to be stackable to allow for more efficient use of refrigerator and/or freezer space.

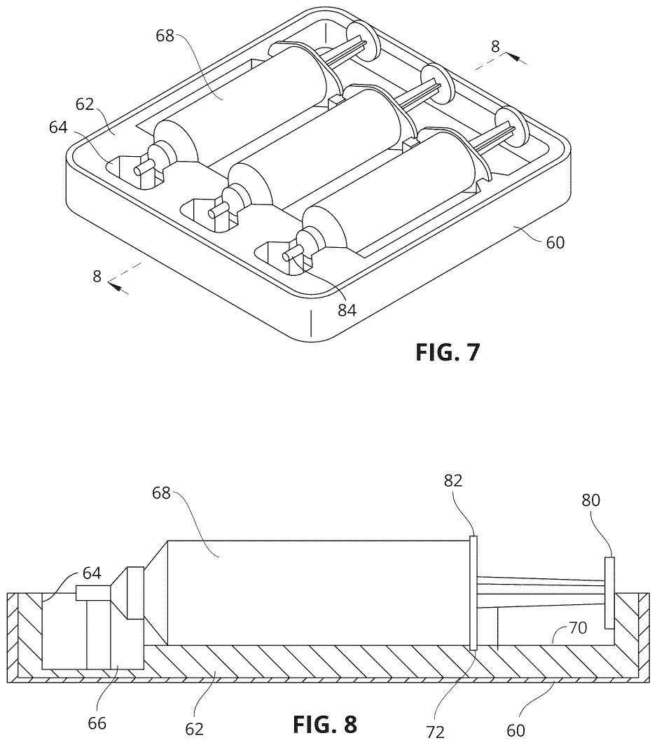

Referring to FIGS. 7 and 8, the present invention provides a breast milk storage system 100 adapted to store syringes pre-loaded with breast milk in a tray insert 62. The tray insert 62 defines a plurality of spaced apart elongated syringe slots 64. Each syringe slot 64 may be a U-shaped or V-shaped channel dimensioned and shaped to secure the cylindrical shape of the barrel of a syringe 68. The floor 70 of the U-channel slot 64 may be sloped so that the fat of the breast milk collects toward the plunger 80 of the syringe 68 so to increase the odds of preserving that element during transportation of the overall system 100 where the overall apparatus may become tilted during transport.

Each syringe slot 64 terminates in a drip well 66 that has a lower elevation relative to the channel slot floor 70, wherein breast milk that does leak from the syringe 68 may be retained for subsequent recollection. The channel slot floor 70 may provide a notch 72 that the barrel flange 82 of the syringe 68 nests in a locked engagement with the notch 72, thereby ensuring that tip 84 of the syringe 68 is disposed suprajacent the drip well 66,

It is understood that even though the tip 84 of the syringe 68 is shown centrally disposed along a distal wall of the barrel, that the tip 84 is off-center or askew relative to the the center of the distal wall. As a result, in the locked engagement the off-center tip 84 is in the “up” position, further away from the drip well 66, thereby again aiming to increase the odds of preserving the loaded milk in situations where the overall apparatus is unbalanced or tilted.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A milk storage system comprising:
a bin dimensioned and shaped to receive a tray insert, wherein the tray insert has a plurality of compartments, each compartment is dimensioned and shaped to receive a fluid container, wherein the fluid container is supported on a base of the compartment so that the fluid container containing the milk is prevented from tilting more than forty-five degrees relative to the base.

2. The milk storage system of claim 1, wherein the plurality of compartments comprises a first compartment having a first circular cross-section and a second compartment having a second circular cross-section, wherein the first circular cross-section is at least twenty percent larger diametrically.

3. The milk storage system of claim 1, wherein the plurality of compartments comprises a first compartment having a circular cross-section and a second compartment having a rectangular cross-section.

4. The milk storage system of claim 1, wherein the plurality of compartments comprises:
a first compartment having a first circular cross-section and a second compartment having a second circular cross-section, wherein the first circular cross-section is at least twenty percent larger diametrically; and
a third compartment having a rectangular cross-section.

5. The milk storage system of claim 1, further comprising a lid dimensioned and shaped to close off an opening of the bin so that another bin can be stacked on the lid in a nested arrangement.

6. The milk storage system of claim 1, further comprising a fluid capture lip along a periphery of an outer perimeter of the tray.

7. The milk storage system of claim 5, wherein the bin, the tray, and the lid are designed from reusable plastic.

8. The milk storage system of claim 5, wherein the bin, the tray, and the lid are designed from disposable plastic.

9. The milk storage system of claim 1, wherein the bin is transparent enabling visualization therethrough.

10. The milk storage system of claim 1, wherein the bin is opaque to protect each fluid container from light exposure.

11. The milk storage system of claim 1, wherein the tray insert has handles.

12. The milk storage system of claim 1, wherein the bin has fingerholes.

13. The milk storage system of claim 1, wherein the tray insert has a raised tab to assist with removal and insertion of the tray insert.

14. The milk storage system of claim 1, wherein the tray insert has a slide pocket for insertion of patient indicia.

15. The milk storage system of claim 1, wherein the tray insert has an identification area for display of patient indicia.

16. The milk storage system of claim 1, wherein the fluid container contains breast milk.

17. The fluid storage system of claim 1,
wherein the plurality of compartments comprises:
a first compartment having a first circular cross-section;
a second compartment having a second circular cross-section, wherein the first circular cross-section is at least twenty percent larger diametrically; and
a third compartment having a rectangular cross-section;
a lid dimensioned and shaped to close off an opening of the bin so that another bin can be stacked on the lid in a nested arrangement; and
a fluid capture lip along a periphery of an outer perimeter of the tray, wherein the bin, the tray, and the lid are designed from reusable or disposable plastic, wherein the bin is transparent enabling visualization therethrough or opaque to protect each fluid container from light exposure,
wherein the tray insert has handles,
wherein the bin has fingerholes,
wherein the tray insert has a raised tab to assist with removal and insertion of the tray insert,
wherein the tray insert has a slide pocket for insertion of patient indicia or an identification area for display of patient indicia, and
wherein the fluid container contains breast milk.

18. A storage system for a plurality of syringes loaded with a milk, the storage system comprising:
a bin dimensioned and shaped to receive a tray insert;
the tray insert defines a plurality of elongated channel slots, each elongated channel slot dimensions and shaped to secure one of a plurality of syringe barrels in a spaced apart relationship relative to each other;
each of the plurality of the elongated channel slots comprises:
a floor having a notch for receiving a portion of a barrel flange of the respective syringe barrel in a locked engagement preventing the syringe barrel from moving longitudinal along the elongated channel slot; and
a drip well disposed at a well elevation lower than an elevation of said floor, where in the locked engagement a tip of the respective syringe barrel is suprajacent the drip well.

19. The storage system of claim 18, wherein the floor is sloped downwardly from the drip well toward a plunger end of the respective syringe barrel.

20. The storage system of claim 18, wherein for each respective syringe barrel a tip thereof is disposed off-center relative a tip wall of the syringe barrel, and wherein the locked engagement the tip is diametrically opposed to the drip well relative a center of said tip wall,
whereby the combination of the off-center and diametrically opposed disposition in combination facilitates accumulation of the colostrum and fat on the top of the loaded milk.
